(19) United States
(12) Patent Application Publication
(10) Pub. No.: US 2022/0057272 A1
(43) Pub. Date: Feb. 24, 2022

(54) ADJUSTABLE WIRELESS COOKING PROBE

(71) Applicant: Haier US Appliance Solutions, Inc., Wilmington, DE (US)

(72) Inventor: James Lee Armstrong, Louisville, KY (US)

(21) Appl. No.: 16/998,122

(22) Filed: Aug. 20, 2020

(51) Int. Cl. G01K 1/02; G01K 1/14

(52) U.S. Cl. CPC G01K 1/024; G01K 2207/06; G01K 1/146

(57) ABSTRACT

A battery-powered temperature probe for measuring the temperature of food products within a cooking utensil. The temperature probe includes a flexible arm that includes a flexible connector that extends between a first end and a second end, each of which include magnets to permit adjustable positioning of the flexible arm on the cooking utensil. In addition. the temperature probe includes a temperature sensor movably mounted to the first end of the flexible arm and being configured for measuring the temperature in the cooking utensil.

### FIELD OF THE INVENTION

The present subject matter relates generally a temperature probe for a cooking appliance, or more specifically, to a temperature probe capable of attaching to a cooking utensil to facilitate versatile temperature measurement of items within the cooking utensil.

### BACKGROUND OF THE INVENTION

Cooktops generally have one or more heating elements configured for heating a cooking utensil. The cooking utensil, e.g., a pot or a pan, may be placed on the cooktop and food products (including, e.g., food solids, liquid, or water) may be placed inside the cooking utensil for cooking. A controller may selectively energize the heating element(s) to provide thermal energy to the cooking utensil and the food products placed therein. Alternatively, certain cooktops, often referred to as induction cooktops, provide energy in the form of an alternating magnetic field which causes the cooking utensil to generate heat. In both types of cooktops, a controller selectively energizes either the heating element(s) or a magnetic coil to heat the food products until they are properly cooked.

Many food products require careful monitoring and control of the cook time and temperature in order to provide optimal cooking results. In order to obtain precise feedback and control of the temperature of the food products as they are heated/cooked, a temperature probe may be placed in thermal communication with the food products. Temperature information is communicated to a control housing, which typically includes control electronics and a display for displaying the temperature of the food products. However, placing such temperature probe in close proximity to the heating element frequently results in internal components of the probe exceeding thermal operating limits, causing premature failure or degradation of the probe. In addition, conventional probes are difficult to adjust, include control electronics positioned outside the cooking utensil such that they are exposed to direct radiant heat from the heating element or flame from the gas burner, and suffer from other operability issues or lack of versatility.

Accordingly, a temperature probe capable of withstanding very high cooking temperatures while maintaining safe and proper operation is desirable. More particularly, a temperature probe that is versatile, adjustable, and is capable of operating in high temperature environments while ensuring safe, proper operation and extended lifetime of the temperature probe would be especially beneficial.

### BRIEF DESCRIPTION OF THE INVENTION

Aspects and advantages of the invention will be set forth in part in the following description, or may be apparent from the description, or may be learned through practice of the invention.

In one exemplary embodiment, a temperature probe for measuring a temperature within a cooking utensil is provided. The temperature probe includes a flexible arm having a first end comprising a first magnet, a second end comprising a second magnet, and a flexible connector that extends between the first end and the second end, the flexible arm being removably attachable to the cooking utensil by positioning the first end proximate an interior side of the cooking utensil such that it is secured by magnetic force and positioning the second end proximate an exterior side of the cooking utensil such that it is secured by magnetic force. A temperature sensor is movably mounted to the first end of the flexible arm and being configured for measuring the temperature in the cooking utensil.

In another exemplary embodiment, a flexible arm for supporting a temperature sensor of a temperature probe on a cooking utensil is provided. The flexible arm includes a first end comprising a first magnet for securing the first end to an interior side of the cooking utensil, the first end of the flexible arm defining a sleeve for slidably receiving a temperature sensor, and wherein the temperature sensor is slidable within the sleeve between an extended position and a retracted position separated by a sensor adjustment height and a second end comprising a second magnet for securing the second end to an exterior side of the cooking utensil. A flexible connector extends between the first end and the second end, wherein the flexible connector is curved between the first end and the second end when installed on the cooking utensil to define a top end and an arm adjustment height between the top end and the first end.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front perspective view of a cooking appliance including a cooktop, a cooking utensil, and a temperature probe attached to the cooking utensil according to an exemplary embodiment of the present subject matter.

FIG. 2 provides a cross sectional side view of the exemplary cooking appliance and temperature probe of FIG. 1.

FIG. 3 provides a perspective view of a cooking utensil and a temperature probe according to an exemplary embodiment of the present subject matter.

FIG. 4 provides a perspective view of the exemplary temperature probe of FIG. 3.

FIG. 5 provides a cross sectional view of a first end, a second end, and a temperature sensor of the exemplary temperature probe of FIG. 3.

FIG. 6 provides a perspective view of a flexible arm of a temperature probe according to an exemplary embodiment of the present subject matter.

FIG. 7 provides a side view of the exemplary flexible arm of FIG. 6.

FIG. 8 provides a perspective view of a flexible arm of a temperature probe according to another exemplary embodiment of the present subject matter.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, terms of approximation, such as “approximately,” “substantially,” or “about,” refer to being within a ten percent (10%) margin of error of the stated value. Moreover, as used herein, the terms “first,” “second,” and “third” may be used interchangeably to distinguish one component from another and are not intended to signify location or importance of the individual components.

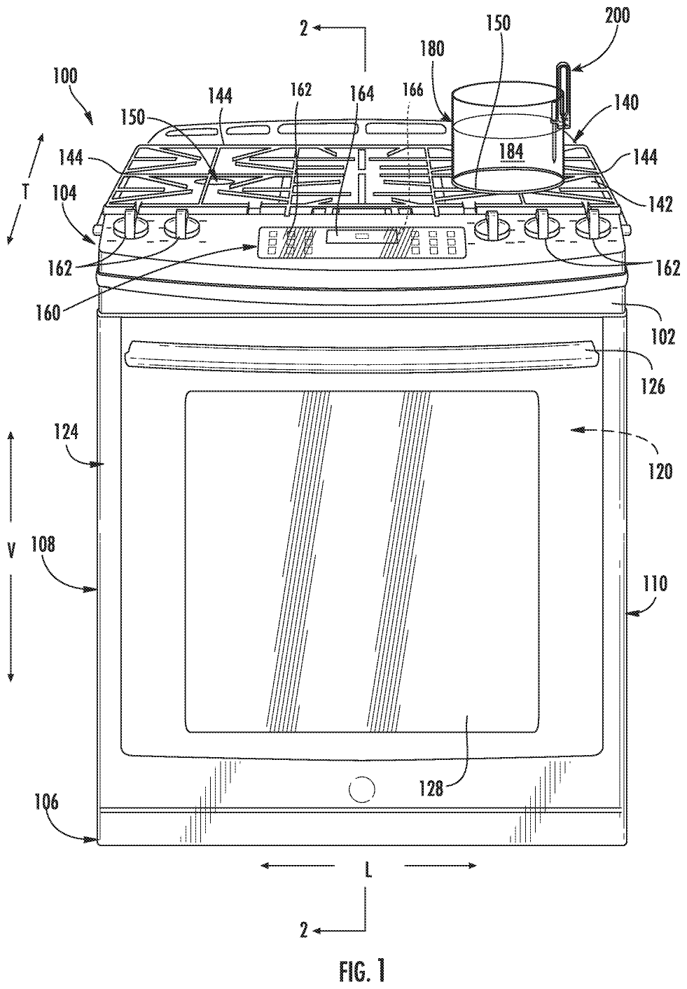

FIG. 1 provides a front, perspective view of an oven appliance 100 as may be employed with the present subject matter. Oven appliance 100 generally defines a vertical direction V, a lateral direction L, and a transverse direction T, each of which is mutually perpendicular, such that an orthogonal coordinate system is generally defined. As illustrated, oven appliance 100 includes an insulated cabinet 102. Cabinet 102 of oven appliance 100 extends between a top 104 and a bottom 106 along the vertical direction V, between a first side 108 (left side when viewed from front) and a second side 110 (right side when viewed from front) along the lateral direction L, and between a front 112 and a rear 114 along the transverse direction T.

Within cabinet 102 is a single cooking chamber 120 which is configured for the receipt of one or more food items to be cooked. However, it should be appreciated that oven appliance 100 is provided by way of example only, and aspects of the present subject matter may be used in any suitable cooking appliance, such as a double oven range appliance. Thus, the example embodiment shown in FIG. 1 is not intended to limit the present subject matter to any particular cooking chamber configuration or arrangement. Indeed, aspects of the present subject matter may be applied to door assemblies for any suitable appliance.

Oven appliance 100 includes a door 124 rotatably attached to cabinet 102 in order to permit selective access to cooking chamber 120. Handle 126 is mounted to door 124 to assist a user with opening and closing door 124 in order to access cooking chamber 120. As an example, a user can pull on handle 126 mounted to door 124 to open or close door 124 and access cooking chamber 120. One or more transparent viewing windows 128 (FIG. 1) may be defined within door 124 to provide for viewing the contents of cooking chamber 120 when door 124 is closed and also assist with insulating cooking chamber 120.

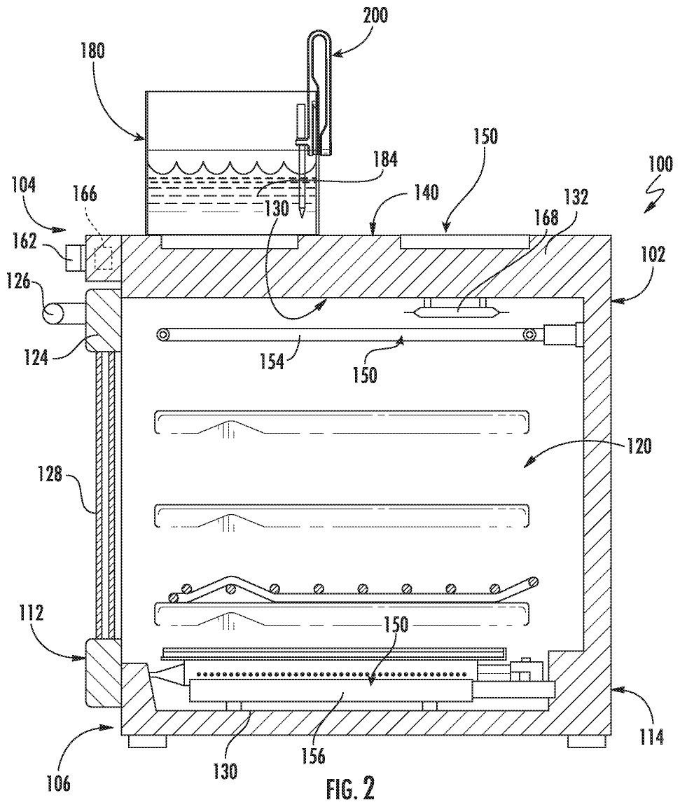

In general, cooking chamber 120 is defined by a plurality of chamber walls 130 (FIG. 2). Specifically, cooking chamber 120 may be defined by a top wall, a rear wall, a bottom wall, and two sidewalls 130. These chamber walls 130 may be joined together to define an opening through which a user may selectively access cooking chamber 120 by opening door 124. In order to insulate cooking chamber 120, oven appliance 100 includes an insulating gap defined between the chamber walls 130 and cabinet 102. According to an exemplary embodiment, the insulation gap is filled with an insulating material 132, such as insulating foam or fiberglass, for insulating cooking chamber 120.

Oven appliance 100 also includes a cooktop 140. Cooktop 140 is positioned at or adjacent top 104 of cabinet 102 such that it is positioned above cooking chamber 120. Specifically, cooktop 140 includes a top panel 142 positioned proximate top 104 of cabinet 102. By way of example, top panel 142 may be constructed of glass, ceramics, enameled steel, and combinations thereof. One or more grates 144 are supported on a top surface of top panel 142 for supporting cooking utensils, such as pots or pans, during a cooking process.

Oven appliance 100 may further include one or more heating elements (identified generally by reference numeral 150) for selectively heating cooking utensils positioned on grates 144 or food items positioned within cooking chamber 120. For example, referring to FIG. 1, heating elements 150 may be gas burners 150. Specifically, a plurality of gas burners 150 are mounted within or on top of top panel 142 such that grates 144 support cooking utensils over gas burners 150 while gas burners 150 provide thermal energy to cooking utensils positioned thereon, e.g., to heat food and/or cooking liquids (e.g., oil, water, etc.). Gas burners 150 can be configured in various sizes so as to provide e.g., for the receipt of cooking utensils (i.e., pots, pans, etc.) of various sizes and configurations and to provide different heat inputs for such cooking utensils. According to alternative embodiments, oven appliance 100 may have other cooktop configurations or burner elements.

In addition, heating elements 150 may be positioned within or may otherwise be in thermal communication with cooking chamber 120 for regulating the temperature within cooking chamber 120. Specifically, an upper gas heating element 154 (also referred to as a broil heating element or gas burner) may be positioned in cabinet 102, e.g., at a top portion of cooking chamber 120, and a lower gas heating element 156 (also referred to as a bake heating element or gas burner) may be positioned at a bottom portion of cooking chamber 120. Upper gas heating element 154 and lower gas heating element 156 may be used independently or simultaneously to heat cooking chamber 120, perform a baking or broil operation, perform a cleaning cycle, etc. The size and heat output of gas heating elements 154, 156 can be selected based on the, e.g., the size of oven appliance 100 or the desired heat output. Oven appliance 100 may include any other suitable number, type, and configuration of heating elements 150 within cabinet 102 and/or on cooktop 140. For example, oven appliance 100 may further include electric heating elements, induction heating elements, or any other suitable heat generating device.

A user interface panel 160 is located within convenient reach of a user of the oven appliance 100. For this example embodiment, user interface panel 160 includes knobs 162 that are each associated with one of heating elements 150. In this manner, knobs 162 allow the user to activate each heating element 150 and determine the amount of heat input provided by each heating element 150 to a cooking food items within cooking chamber 120 or on cooktop 140. Although shown with knobs 162, it should be understood that knobs 162 and the configuration of oven appliance 100 shown in FIG. 1 is provided by way of example only. More specifically, user interface panel 160 may include various input components, such as one or more of a variety of touch-type controls, electrical, mechanical or electro-mechanical input devices including rotary dials, push buttons, and touch pads. User interface panel 160 may also be provided with one or more graphical display devices or display components 164, such as a digital or analog display device designed to provide operational feedback or other information to the user such as e.g., whether a particular heating element 150 is activated and/or the rate at which the heating element 150 is set.

Generally, oven appliance 100 may include a controller 166 in operative communication with user interface panel 160. User interface panel 160 of oven appliance 100 may be in communication with controller 166 via, for example, one or more signal lines or shared communication busses, and signals generated in controller 166 operate oven appliance 100 in response to user input via user input devices 162. Input/Output (“I/O”) signals may be routed between controller 166 and various operational components of oven appliance 100 such that operation of oven appliance 100 can be regulated by controller 166. In addition, controller 166 may also be communication with one or more sensors, such as temperature sensor 168 (FIG. 2), which may be used to measure temperature inside cooking chamber 120 and provide such measurements to the controller 166. Although temperature sensor 168 is illustrated at a top and rear of cooking chamber 120, it should be appreciated that other sensor types, positions, and configurations may be used according to alternative embodiments.

Controller 166 is a “processing device” or “controller” and may be embodied as described herein. Controller 166 may include a memory and one or more microprocessors, microcontrollers, application-specific integrated circuits (ASICS), CPUs or the like, such as general or special purpose microprocessors operable to execute programming instructions or micro-control code associated with operation of oven appliance 100, and controller 166 is not restricted necessarily to a single element. The memory may represent random access memory such as DRAM, or read only memory such as ROM, electrically erasable, programmable read only memory (EEPROM), or FLASH. In one embodiment, the processor executes programming instructions stored in memory. The memory may be a separate component from the processor or may be included onboard within the processor. Alternatively, controller 166 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

Although aspects of the present subject matter are described herein in the context of a single oven appliance, it should be appreciated that oven appliance 100 is provided by way of example only. Other oven or range appliances having different configurations, different appearances, and/or different features may also be utilized with the present subject matter, e.g., double ovens, standalone cooktops, etc.

As illustrated in FIGS. 1 and 2, oven appliance 100 may be designed for receiving and heating a cooking utensil 180. In general, cooking utensil 180 is a vessel or container configured for receiving food products 182, cooking fluid or liquid 184, and/or other contents to facilitate a cooking process. Although cooking utensil 180 and the temperature probe 200 (described below) are described and illustrated herein as being positioned on a gas burner 150 of oven appliance 100, it should be appreciated that aspects of the present subject matter may be used in any other suitable cooking appliance, environment, or position. For example, cooking utensil 180 may be positioned on another gas burner 150, within cooking chamber 120, or at any other suitable location within any other suitable appliance to facilitate a cooking process. Thus, the present subject matter may be used with other cooking appliances having different cooktop and heating element types and configurations (e.g., radiant, gas, induction, etc.), and may also be used with different types of cooking utensils.

As used herein, “food products” (referred to generally by reference numeral 182) may refer to any solid or liquid intended to be cooked and eaten, in contrast to “cooking liquid” (referred to generally by reference numeral 182, which may be used to heat the food products, e.g., via boiling or to facilitate a sous vide cooking process. As explained in more detail below, the temperature probe disclosed herein is capable of measuring either the food product directly or the cooking liquid, e.g., to facilitate a sous vide process.

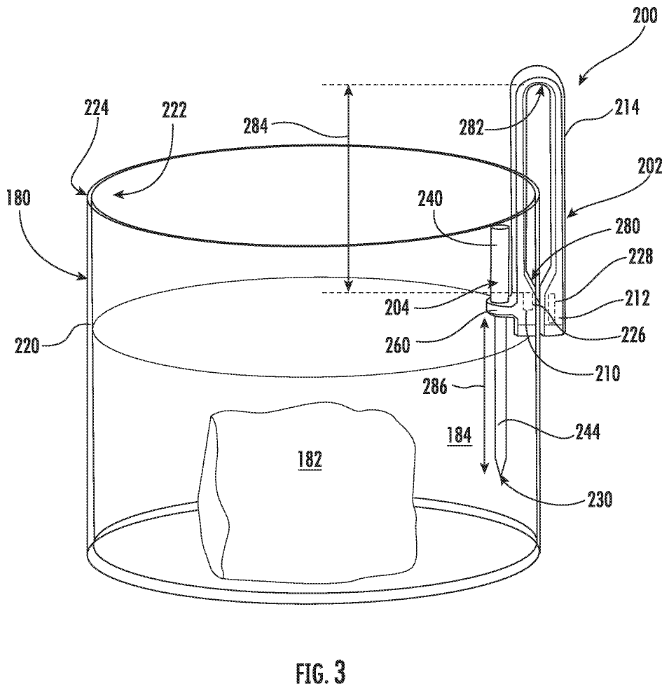

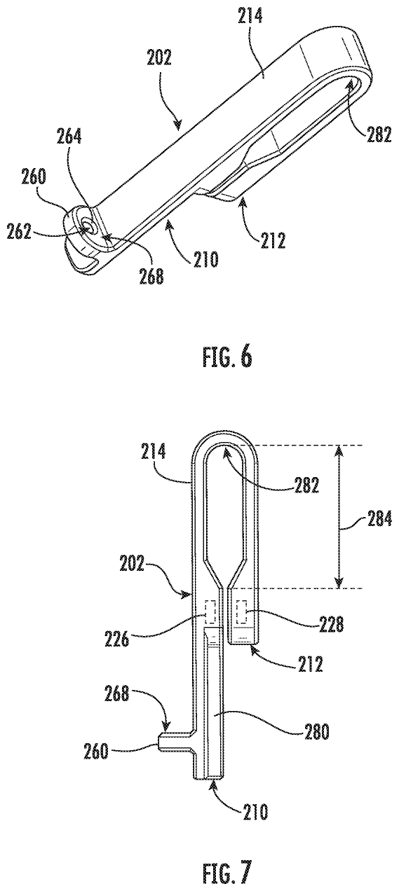

Referring now to FIGS. 3 through 8, various temperature probes 200 will be described according to various embodiments of the present subject matter. Due to the similarity of the embodiments described, like reference numerals may be used to refer to the same or similar features among embodiments. In addition, it should be appreciated that aspects or features of different embodiments may be used alternatively as part of another embodiment or features described herein may be merged or modified to create a new embodiment in accordance with aspects of the present subject matter. The embodiments described herein are only exemplary, are intended only to facilitate explanation of aspects of the present subject matter, and are not intended to limit the scope of the disclosure in any manner.

As illustrated, temperature probe 200 generally includes a flexible arm 202 that is configured for mounting a temperature sensor 204 onto a cooking utensil (e.g., such as cooking utensil 180) and positioning temperature sensor 204 in a manner to facilitate temperature measurement of food products 182, liquids 184, or both. Specifically, flexible arm 202 includes a first end 210 and a second end 212 that are joined by a flexible connector 214 that extends between first end 210 and second end 212. To mount temperature probe 200 on cooking utensil 180, flexible arm 202 may be placed over a side 220 of cooking utensil 180. First end 210 and second end 212 may be removably attached to an interior surface 222 and an exterior surface 224, respectively, of side 220 of cooking utensil 180.

Notably, due to its position during operation, flexible arm 202 must be able to withstand very high temperatures. According to the illustrated embodiment, flexible arm 202 is made of silicone rubber. Silicone rubber is capable of withstanding very high temperatures while remaining flexible. In addition, silicone rubber is also non-toxic, is not prone to cracking or deteriorating, and acts as an insulator to limit the conduction of heat to the various portions of temperature probe 200. However, one skilled in the art will appreciate that flexible arm 202 may be made from any suitably flexible and durable material that can withstand high temperatures.

According to an exemplary embodiment, flexible arm 202 may be attached to cooking utensil 180 using magnets. For example, as shown in the figures, flexible arm 202 may have a first magnet 226 positioned within or mounted to first end 210 and a second magnet 228 positioned within or mounted to second end 212. In other words, first magnet 226 may be proximate temperature sensor 204, and second magnet 228 may be distal from temperature sensor 204 along the flexible arm 202. Magnets 226, 228 may be attached to flexible arm 202 after it is molded, for example, by using an adhesive or mechanical fastener. Alternatively, magnets 226, 228 may be incorporated into a mold prior to molding flexible arm 202, such that they may be integrally molded within flexible arm 202. In addition, magnets 226, 228 may be positioned and oriented within flexible arm 202 such that the magnetic poles attract each other when flexible arm 202 is placed over side 220 of cooking utensil 180.

Flexible arm 202 may be attached to cooking utensil 180 by placing first end 210 and second end 212 at the desired position on cooking utensil 180. For example, as shown in FIG. 3, first end 210 is placed on interior surface 222 such that it is secured by magnetic force to cooking utensil 180, which is typically ferromagnetic. In this manner, first end 210 of flexible arm 202 is magnetically attachable to cooking utensil 180 such that temperature sensor 204 may be selectively positioned and fixed within food products 182—e.g., at a height where a tip 230 of temperature sensor 204 is positioned at a desirable depth within food products 182 for precise temperature monitoring. Similarly, second end 212 may be placed on exterior surface 224 of cooking utensil 180 such that it is secured by magnetic force.

In cases where cooking utensil 180 is not ferromagnetic, flexible arm 202 may still be secured to cooking utensil 180 by positioning first end 210 and second end 212 of flexible arm 202 near interior surface 222 and exterior surface 224, respectively, such that the magnetic force between first magnet 226 and second magnet 228 draw first end 210 and second end 212 toward each other and generate a clamping force on side 220 of cooking utensil 180. In this regard, first magnet 226 and second magnet 228 should be positioned within first end 210 and second end 212, respectively, such that their opposing polarities generate an attractive force when placed on either side of the cooking utensil 180 (i.e., the orientation shown in FIG. 3).

Temperature sensor 204 extends from first end 210 of flexible arm 202 and may be configured for measuring the temperature of food products 182 in cooking utensil 180. In this regard, tip 230 of temperature sensor 204 may be placed in food products 182 as desired to determine the temperature of food products 182. Specifically, temperature sensor 204 may be mounted to flexible arm 202 such that it is in thermal contact with food products 182 in cooking utensil 180 in order to measure the temperature of food products 182.

Temperature sensor 204 may generally include a housing 240 and an insertion probe 244 that extends out of a bottom of housing 240 toward tip 230 at a distal end of insertion probe 244. Control electronics (identified generally by reference numeral 242) may be positioned at any suitable location within temperature sensor 204 for insulating sensitive electronics from unsuitably high heat. For example, according to the exemplary embodiment, control electronics 242 are positioned within insertion probe 244, where the food products 182 and/or liquid 184 helps keep these components cool.

In general, temperature sensor 204, or more particularly, insertion probe 244, may include a thermocouple, a thermistor, or any other device suitable for measuring the temperature of food products 182 or liquid 184 within cooking utensil 180. According to exemplary embodiments, temperature sensor 204 may be positioned entirely within the cooking utensil 180 when the temperature probe 200 is installed. In this regard, insertion probe 244 and housing 240 may be mounted to flexible arm 202 such they are both positioned entirely below a top of cooking utensil 180. In this manner, temperature sensor is protected from direct radiant energy or flame from the heating element 150, a lid may be more easily placed on top of cooking utensil 180, etc.

Flexible arm 202 is generally configured for positioning tip 230 of temperature sensor 204 in a desired position for measuring temperatures, while housing 240 provides a thermally isolated and enclosed environment for containing control electronics 242, which may include various electronic components for facilitating temperature measurement, external communication, and probe operation. Exemplary electronic components and control electronics 242 are described herein, though one skilled in the art will appreciate that additional or alternative electronic components may be used while remaining scope of the present subject matter.

According to an exemplary embodiment, temperature sensor 204 is entirely removable from flexible arm 202 and may operate independently of flexible arm 202. In this manner, control electronics 242 may be entirely contained within temperature probe such that it may be used without flexible arm 202. For example, a user may stick tip 230 of temperature sensor 204 into a food product 182, e.g., such as a piece of meat that is being cooked. During such operation, flexible arm 202 may or may not be mounted to a cooking utensil 180. By contrast, temperature sensor 204 may be mounted to flexible arm 202 such that flexible arm 202 and/or temperature sensor 204 may be moved relative to each other and relative to cooking utensil 180 to provide a wide range of sensor positions. Notably, this dual adjustment feature of temperature probe 200 facilitates versatile positioning and temperature measurement, e.g., to measure different size food products 182 and/or liquids 184 at any suitable height or position within cooking utensil 180.

In general, control electronics 242 may include a control board, various signal wires, a wireless communication module, a battery, and any other components for facilitating improved probe operation. Many of these components may exhibit improved performance and lifetime if maintained below very high operating temperatures, and these components are thus thermally isolated within housing 240. Control electronics 242 may include control board 246, e.g., a printed circuit board, having controller positioned thereon and being operatively connected to temperature sensor 204. The controller may be configured to control the operation of temperature probe 200, e.g., and may be similar to controller 166 in many respects. Thus, control board 246 may include one or more processor(s) and associated memory device(s) configured to perform a variety of computer-implemented functions. Control board 246 may be operatively connected to temperature sensor 204 via signal wires (or wirelessly), and may be configured to receive temperature data from insertion probe 244. As discussed below, temperature probe 200 may transmit this temperature data to controller 166 of oven appliance 100 and may also display the temperature, or other relevant information, on display 164.

According to the illustrated embodiment, control electronics 242 may also include a power source for operating temperature probe 200. For example, according to the illustrated embodiment, temperature probe 200 is battery-powered and may include a rechargeable lithium-ion battery 248. However, one skilled in the art will appreciate that battery 248 is only one exemplary power source and others may be used as well. For example, other types of batteries may be used, or even other types of energy storage components, such as capacitors or fuel cells. Alternatively, temperature probe 200 may be tethered to oven appliance 100 and may receive power directly from controller 166.

A wireless communication module 250 may also be included to communicate temperature information as described herein. For example, wireless communication module 250 may communicate temperature measurements to controller 166 of oven appliance 100, to display 164, to a user's mobile device, or to any other display or controller. More specifically, for example, controller 166 may be in operative communication with wireless communication module 250 to facilitate communications between control board 246 and various other components of oven appliance 100. For instance, wireless communication module 250 may serve as an interface to permit control board 246 to transmit and/or receive signals associated with the temperature of food products 182 and/or liquids 184. Communications between temperature probe 200 and the oven appliance 100 may be achieved using any suitable wireless communication protocol, for example, WiFi, ZigBee, Bluetooth, and others.

During operation, controller 166 may receive the measured temperature data from wireless communication module 250 and selectively energize heating elements 150 to maintain a desired temperature of food products 182 or liquids 184 responsive to the measured temperature from temperature probe 200. In this manner, controller 166 may receive instantaneous feedback regarding the actual temperature of food products 182 within cooking utensil 180, resulting in closed loop feedback that may optimize control of heating elements 150. Controller 166 may then adjust heating element 150 to ensure the temperature is precisely controlled to match the desired cooking temperature or a specific cooking temperature profile.

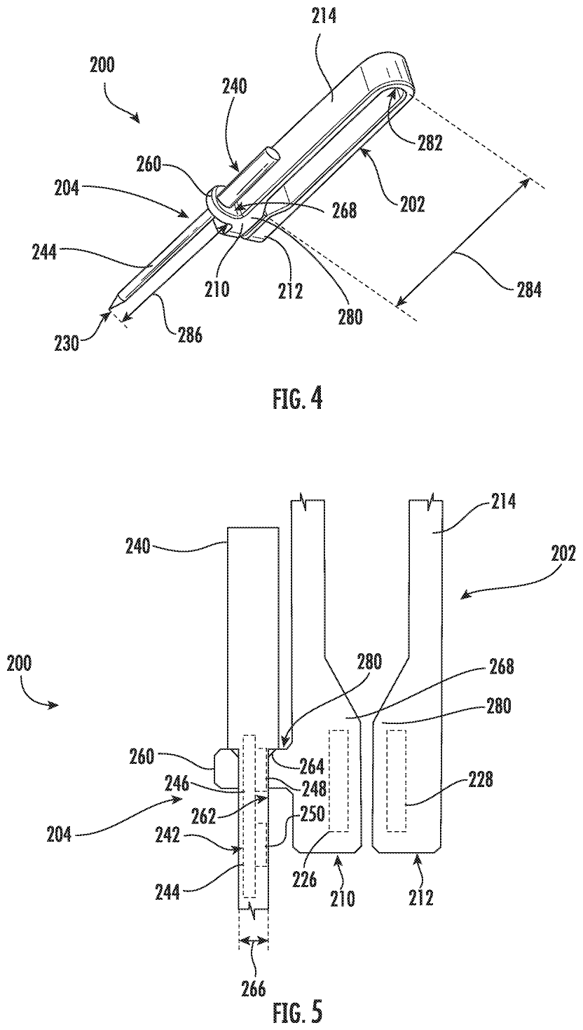

According to exemplary embodiments, temperature probe 200 may include features for properly positioning temperature sensor 204 within food products 182 and/or liquids 184. For example, as described above, temperature sensor 204 may be movably mounted relative to flexible arm 202 for improved versatility and positioning of temperature sensor 204. Specifically, according to the illustrated embodiment, flexible arm 202 may define one or more sleeves 260 that are configured for slidably receiving temperature sensor 204. Specifically, as best illustrated in FIGS. 4 and 5, flexible arm 260 may define a sleeve 260 at first end 210. Sleeve 260 defines an aperture 262 through which insertion probe 244 of temperature sensor 204 may be inserted. In order to simplify insertion of temperature sensor 204 into sleeve 260, sleeve 260 may define a chamfered edge 264 at the inlet of aperture 262. In this manner, a user may install temperature sensor 204 quickly and easily while avoiding prolonged exposure to the high heat generated during a cooking process.

According to an exemplary embodiment, aperture 262 is smaller than a diameter 266 (e.g., see FIG. 5) of insertion probe 244 such that an interference fit is formed between sleeve 260 and insertion probe 244. In this manner, a user may force insertion probe 244 through aperture 262, after which friction between the sleeve 260 and temperature sensor 204 cause the temperature sensor 204 to remain in place during the cooking process. It should be appreciated that sleeve 260 may define additional features for securing temperature sensor 204 in place, such as ridges, bumps, latches, clips, or other suitable mechanisms for restricting insertion probe 244 from sliding within sleeve 260. For example, sleeve 260 further defines a shoulder 268 (e.g., where chamfered edge 264 is defined) and housing 240 may have a larger diameter than diameter 266 of aperture 262. In this manner, temperature sensor 204 is prevented from sliding further than the point at which housing 240 engages shoulder 268.

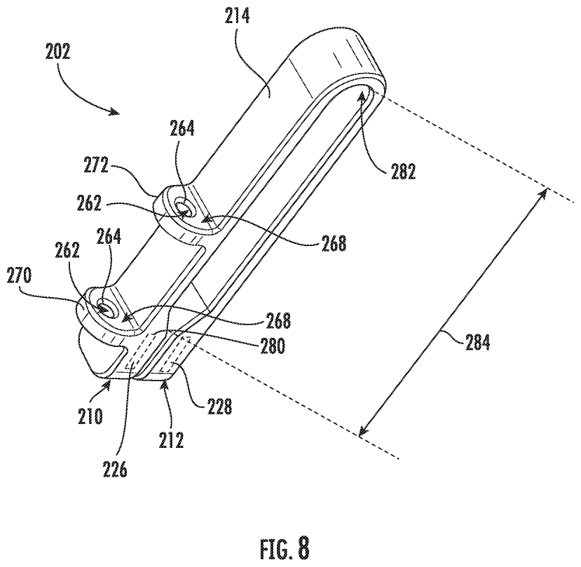

According to still other embodiments, flexible arm 202 may include more than one sleeve 260 for positioning temperature sensor 204. Specifically, as best illustrated in FIG. 8, flexible arm 202 may define a lower sleeve 270 at first end 210 and an upper sleeve 272 on flexible connector 214 above first end 210. To install temperature sensor 204, a user may slide insertion probe 244 first through the upper sleeve 272 and then through lower sleeve 270 until the desired depth within cooking utensil 180 is achieved. It should be appreciated that according to alternative embodiments more than two sleeves 260 may be used and flexible arm 202 may define additional features for properly positioning temperature sensor 204 within cooking utensil 180.

According to an exemplary embodiment, flexible arm 202, or more specifically first end 210 and second end 212 may define additional features to facilitate improved positioning of temperature sensor 204. For example, first end 210 may define a protruding sensor support surface 280 that keeps temperature sensor 204 away from side 220 of cooking utensil 180. For example, according to the embodiment illustrated in FIG. 5, support surface 280 is simply additional mass defined on an interior side of first end 210 (and second end 212) that has a width approximately equivalent to a width of flexible connector 214. By contrast, as illustrated for example in FIG. 7, support surface 280 may be a T-shaped protrusion extending from first end 210, e.g., to minimize material usage while maintaining a rigid standoff and minimizing a pathway for thermal conduction. Other shapes and configurations of support surface 280 are possible and within the scope of the present subject matter.

In addition, according to some exemplary embodiments, temperature sensor 204 may extend from first end 210 such that it forms and angle relative to vertical direction V when attached to side 220 of cooking utensil 180. In this regard, for example, aperture 262 may be defined through sleeve 260 in a non-vertical direction, e.g., at an angle of 10°, 20°, 30°, 40°, or greater, relative to the vertical direction V. In addition, according to still other embodiments, the first end 210 of flexible arm 202 may include additional movable features for selectively adjusting the standoff or angle of sleeve 260, and thus temperature sensor 204, when installed. For example, flexible arm 202 may include one or more foldable members that may be folded into position between sleeve 260 and side 220 of cooking utensil 180. In addition, or alternatively, flexible arm 202 may include a malleable joint that joins flexible connector 214 to first end 210. In this manner, a user may manipulate first end 210 until it is positioned at the desired orientation, after which the malleable joint will thereafter hold first end 210 in position.

Referring again briefly to FIG. 3, when temperature probe 200 is installed, flexible connector 214 is generally curved between first end 210 and second end 212 such that a top end 282 of flexible connector 214 is defined. As explained above, temperature probe 200 provides adjustment of flexible arm 202 relative to cooking utensil 180 as well as adjustment of temperature sensor 204 within flexible arm 202. Specifically, flexible arm 202 may define an arm adjustment height 284 between top end 282 and first end 210, e.g., along which flexible arm 202 may slide up and down relative to cooking utensil 180. In addition, temperature sensor 204 may be slidable within sleeve 260 between an extended position and a retracted position separated by a sensor adjustment height 286 notably, the use of both the adjustment mechanisms provides for increased versatility and length of positioning, e.g., for deeper pots, shallower pots, or other unique insertion positions. For example, according to exemplary embodiments, arm adjustment height 284 is greater than sensor adjustment height 286. By contrast, sensor adjustment height 286 may be greater than arm adjustment height 284. Other configurations of temperature probe 200 are possible and within the scope of the present subject matter.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A temperature probe for measuring a temperature within a cooking utensil, the temperature probe comprising:
a flexible arm having a first end comprising a first magnet, a second end comprising a second magnet, and a flexible connector that extends between the first end and the second end, the flexible arm being removably attachable to the cooking utensil by positioning the first end proximate an interior side of the cooking utensil such that it is secured by magnetic force and positioning the second end proximate an exterior side of the cooking utensil such that it is secured by magnetic force; and
a temperature sensor movably mounted to the first end of the flexible arm and being configured for measuring the temperature in the cooking utensil.

2. The temperature probe of claim 1, wherein the first end of the flexible arm defines a sleeve for slidably receiving the temperature sensor.

3. The temperature probe of claim 2, wherein the sleeve defines an aperture defined by a chamfered edge to facilitate receipt of the temperature sensor.

4. The temperature probe of claim 2, wherein the aperture is smaller than a diameter of an insertion probe of the temperature sensor such that an interference fit is formed between the sleeve and the insertion probe.

5. The temperature probe of claim 2, wherein the sleeve defines a shoulder, and wherein a housing of the temperature sensor is seated against the shoulder when the temperature sensor is inserted through the sleeve.

6. The temperature probe of claim 1, wherein a lower sleeve is defined at the first end and an upper sleeve is defined on the flexible connector above the first end, the temperature sensor being slidably positioned through the upper sleeve and the lower sleeve.

7. The temperature probe of claim 1, wherein the temperature sensor comprises:
a housing configured for containing control electronics for the temperature sensor; and
an insertion probe that extends out of a bottom of the housing.

8. The temperature probe of claim 7, wherein control electronics comprise:
a battery; and
a wireless communication module.

9. The temperature probe of claim 8, wherein the battery is a rechargeable lithium-ion battery.

10. The temperature probe of claim 1, wherein the flexible arm is constructed from silicone.

11. The temperature probe of claim 1, wherein the flexible connector is curved between the first end and the second end when installed on the cooking utensil to define a top end and an arm adjustment height between the top end and the first end, and wherein the temperature sensor is slidable within a sleeve between an extended position and a retracted position separated by a sensor adjustment height.

12. The temperature probe of claim 11, wherein the arm adjustment height is greater than the sensor adjustment height.

13. The temperature probe of claim 1, wherein the first magnet and the second magnet have opposite polarities such that the magnetic force between the first magnet and the second magnet secures the flexible arm to the cooking utensil.

14. The temperature probe of claim 1, wherein the temperature sensor is positioned entirely within the cooking utensil when the temperature probe is installed.

15. The temperature probe of claim 1, wherein the first end of the flexible arm defines a support surface configured for contacting the interior side of the cooking utensil to space the first end away from the interior surface of the cooking utensil.

16. The temperature probe of claim 1, wherein the temperature sensor is a thermistor.

17. The temperature probe of claim 1, wherein the temperature is measured within a food item or within liquid stored in the cooking utensil.

18. A flexible arm for supporting a temperature sensor of a temperature probe on a cooking utensil, the flexible arm comprising:
a first end comprising a first magnet for securing the first end to an interior side of the cooking utensil, the first end of the flexible arm defining a sleeve for slidably receiving a temperature sensor, and wherein the temperature sensor is slidable within the sleeve between an extended position and a retracted position separated by a sensor adjustment height;
a second end comprising a second magnet for securing the second end to an exterior side of the cooking utensil; and
a flexible connector extending between the first end and the second end, wherein the flexible connector is curved between the first end and the second end when installed on the cooking utensil to define a top end and an arm adjustment height between the top end and the first end.

19. The flexible arm of claim 18, wherein the sleeve defines an aperture defined by a chamfered edge to facilitate receipt of the temperature sensor, wherein the aperture is smaller than a diameter of an insertion probe of the temperature sensor such that an interference fit is formed between the sleeve and the insertion probe.

20. The flexible arm of claim 18, wherein the arm adjustment height is greater than the sensor adjustment height.
